(19) United States
(12) Patent Application Publication
(10) Pub. No.: US 2005/0199442 A1
(43) Pub. Date: Sep. 15, 2005

(54) Climbing device

(76) Inventor: James H. Stidham, Edmonton, KY (US)

Correspondence Address: JAMES RAY & ASSOCIATES, 2640 PITCAIRN ROAD, MONROEVILLE, PA, 15146, US

(21) Appl. No.: 11/080,741

(22) Filed: Mar. 15, 2005

Related U.S. Application Data
(60) Provisional application No. 60/553,229, filed on Mar. 15, 2004.

(51) Int. Cl. E06C 7/00

(52) U.S. Cl. 182/92

(57) ABSTRACT

A portable climbing device for facilitating ascending and descending a tree, a pole and like structures includes a bracket having a step portion and attached to the structure with a flexible cable. The ends of the flexible cable are received by a plurality of apertures disposed within the bracket and are clamped by a bolt and a nut for secure attachment to the bracket. There is a fulcrum at one end of the bracket which generates a tension in the flexible cable during installation. A friction producing material is applied to a portion of such bracket for providing positive foot traction. A reflective coating or a reflective tape may be used for visual identification of the bracket, particularly in the darkness.

### CROSS-REFERENCE TO RELATED APPLICATIONS

This application is related to and claims priority from U.S. Provisional Patent Application Ser. No. 60/553,229 filed Mar. 15, 2004.

### FIELD OF THE INVENTION

The present invention relates, in general, to climbing device to facilitate ascending and descending of upright structures such as trees, poles and the like and, more particularly, the instant invention relates to a portable climbing device and, yet more particularly, this invention relates to a portable climbing device which can be securely attached to the structure without the use of tools.

### BACKGROUND OF THE INVENTION

Climbing devices and, particularly, portable climbing devices commonly known as tree steps have been widely used for aiding individuals in ascending and descending trees or pole like structures. They enable hunters to easily and safely ascend up to and descend down from a tree stand or provide a temporary support for trimming and pruning tree branches.

Portable climbing devices of the prior art have several disadvantages. Some devices, as taught by U.S. Pat. No. 5,944,139 to Kozial and U.S. Pat. No. 6,729,437 to Apple include a sharp projection which is used to penetrate the surface of the tree thus potentially providing permanent damage to the tree.

U.S. Pat. No. 6,729,437 to Apple further provides for the use of a special tool to attach such device to the tree, pole or the like.

Another type of portable climbing device taught by U.S. Pat. No. 4,109,761 to Matlock and U.S. Pat. No. 3,767,011 to Witt use chains for attaching such devices which add to the carrying weight, particularly if a plurality of such devices must be used for climbing purposes.

Most presently available portable climbing devices provide a narrow foot supporting portion which may allow for pivoting of the foot during climbing thus providing for an unsafe condition.

Therefore, there is a need for an improved climbing device that does not damage the upright structure during installation, provides an adequate foot support surface and is relatively easy to install without the use of tools.

### SUMMARY OF THE INVENTION

The present invention provides a climbing device for facilitating ascending and descending a tree, a pole and the like. The climbing device includes a step bracket having a first portion at least partially engaging the structure and a second portion which outwardly extends from one end of the first portion and is horizontally disposed in the final installed position. A flexible cable is provided for attachment of the step bracket to the structure. The flexible cable is wrapped around the structure and has ends received by a plurality of apertures disposed within the first portion of the bracket. The cable ends are looped around the edges of the first portion for securement of the flexible cable to the step bracket and may be additionally secured to the surface of the first portion with a bolt and a nut. The other end of the first portion is provided with a fulcrum portion which generates tension in the flexible cable during installation when the step bracket is moved from a first position wherein the first portion is generally horizontal to a second position wherein the first portion is generally vertical at least partially engaging the structure and the second portion is generally horizontal. A flange extends from the second portion and is angularly aligned in a vertical direction for guiding a person's foot for engagement with such second portion. A friction producing material is adhered to the second portion for providing a positive traction with the person's foot.

A reflective tape or a reflective coating may be applied to the flexible cable or the step bracket for ease of visual identification of the climbing device during darkness or nightfall.

### OBJECTS OF THE INVENTION

It is, therefore, one of the primary objects of the present invention to provide a climbing device which is suitable for use in climbing trees, poles and the like.

Another object of the present invention is to provide a climbing device which is portable.

Yet another object of the present invention is to provide a climbing device which is free of sharp mounting projections penetrating the surface of the structure.

A further object of the present invention is to provide a climbing device which can be installed without the use of tools.

Yet a further object of the present invention is to provide a climbing device which provides an adequate foot support surface.

An additional object of the present invention is to provide a climbing device which provides a positive traction with a person's foot.

Yet another object of the present invention is to provide a climbing device which is easily identified at night.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a climbing device of the present invention;

FIG. 2 is a partial perspective view of the climbing device of FIG. 1, particularly showing attachment means of a preferred embodiment;

FIG. 3 is a partial elevation view of the climbing device of FIG. 1, particularly showing attachment means of an alternative embodiment;

FIG. 4 is a plan view of the climbing device of FIG. 1, particularly showing attachment means of yet another alternative embodiment

FIG. 5 is an elevation view of the climbing device of the preferred embodiment of the present invention particularly showing an attachment thereof to a structure in a first position; and

FIG. 6 is an elevation view of the climbing device of the preferred embodiment of the present invention particularly showing an attachment thereof to the structure in a second position.

### BRIEF DESCRIPTION OF THE VARIOUS EMBODIMENTS OF THE PRESENT INVENTION

Prior to proceeding to the more detailed description of the present invention, it should be noted that, for the sake of clarity and understanding, identical components which have identical functions have been identified with identical reference numerals throughout the several views illustrated in the drawing figures.

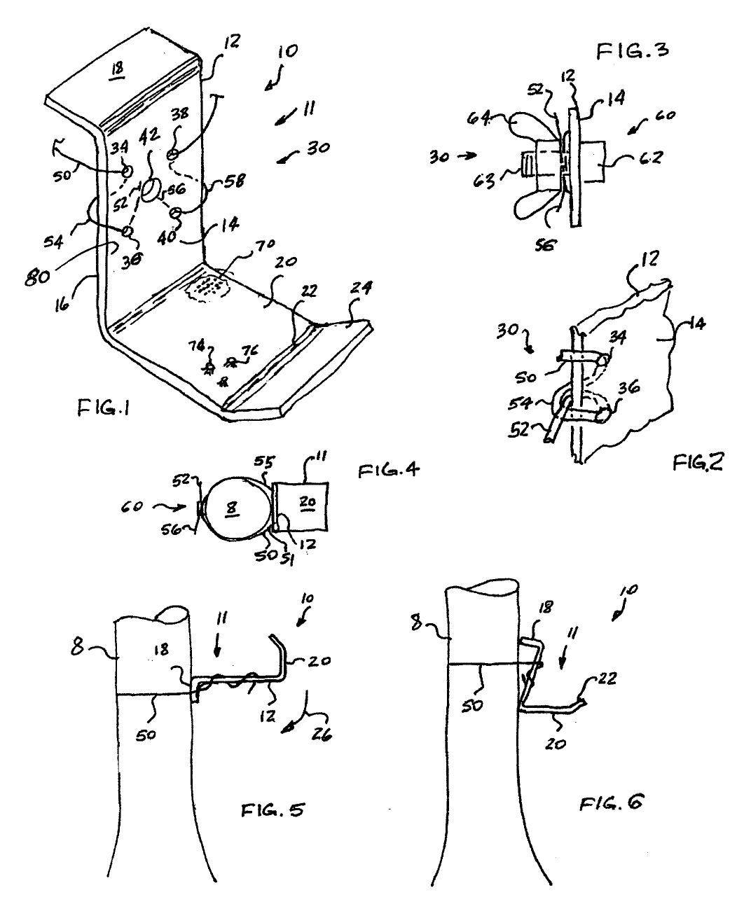

Now in reference to FIGS. 1-6, therein shown a climbing device of the present invention, generally designated 10, including a step member, generally designated 11, having a predetermined shape and a predetermined width for attachment to a tree, pole or a like vertical structure 8. In particular reference to FIG. 1, the step member 11 includes a first portion 12 having a first predetermined surface area and having a front surface 14 and an opposed rear surface 16. One end of the first portion 12 is adapted with a fulcrum means 18, which is, preferably, a flange 18 outwardly extending in a direction of the rear surface 16 of the first portion 14. Alternatively, such fulcrum means 18 may be at least partially formed generally round in its cross-section.

A second portion 20 having a second predetermined surface area is outwardly extending from the distal end of the first surface portion 12 in a direction of the front surface 14 in a manner that when the step member 11 is attached to the structure 8 in a second position, best shown in FIG. 6, such second surface portion 20 is disposed generally horizontally for supporting a person's foot (not shown). Preferably, such second predetermined surface area of the second portion 20 prevents pivoting of the person's foot (not shown) upon engagement therewith.

The climbing device 10 may be adapted with means 24 for guiding placement of such foot (not shown) onto the second surface portion 20 which, in a preferred embodiment, is a third portion 24, preferably having a third predetermined surface area, extending from an edge 22 of the second surface portion 20 and aligned at a predetermined angle thereto enabling such third surface portion 24 to be aligned in an upward direction when the step member 11 is in the second position.

The material of such step member 11 may be either a metal or a rigid polymer and such step member 11 may be manufactured by any well known processes including but not limited to casting, forming, extrusion and stamping. It will be appreciated that such step member 11 may be formed by a combination of such metal and rigid polymer materials to further reduce its weight.

The climbing device 10 is provided with means, generally designated 30, for selectively attaching such step member 11 to and removing it from the structure 8. In the presently preferred embodiment, such means 30 includes a predetermined plurality of apertures 34-40 having a predetermined shape and disposed in a first predetermined pattern within the first portion 12 and an elongated flexible means 50, engageable with such predetermined plurality of apertures 34-40 and the first portion 12 and engageable with the structure 8. Such elongated flexible means 50 may include but is not be limited to cable, chain, rope and strap. Preferably, such elongated flexible means 50 is a flexible cable. The preferred material of such flexible cable is metal. Alternatively, the material of such flexible cable 50 may be a polymer or a polymer and metal combination.

Advantageously, such predetermined shape of the predetermined plurality of apertures 34-40 is slightly larger than the shape of the elongated flexible means 50.

In a most preferred embodiment, such predetermined plurality of apertures 34-40 is a first pair of apertures 34 and 36 aligned adjacent one edge of the first surface portion 12 and a second pair of apertures 38 and 40 aligned adjacent the other edge of the first surface portion 12.

Attachment of the elongated flexible means 50 to the first surface portion 12 is best illustrated in FIGS. 2, 5 and 6. In a particular reference to FIG. 2, a first end 52 of the elongated flexible means 50 is first inserted through the aperture 34 from the front surface 14, then wrapped around the edge of the first surface portion 12 and additionally inserted through the aperture 36 thus forming a first loop 54 of the elongated flexible means 50 with the first surface portion 12. The end 52 is then inserted through such loop 54 and the flexible means 50 is placed in tension to secure such end 52. The step member 11 is then placed in a first position with the fulcrum means 18 engaging the structure 8, as best shown in FIG. 5. The elongated flexible means 50 is then wrapped around the structure 8 and the second end 56 is secured in identical manner to the other pair of aligned apertures 38 and 40 forming a second loop 58. The climbing device is then downwardly rotated in a direction 26 around the fulcrum means 18 and placed into a second position, best illustrated in FIG. 6, wherein at least a portion of the rear surface 16 of the first surface portion 12 engages the structure 8. It will be appreciated that a significant tension is generated in the elongated flexible means 50 upon rotation of the step member 11 into the second position and such significant tension will secure the step member 11 to the structure 8.

In an alternative embodiment, the means 30 may be further provided with a clamping means, generally designated 60, best shown in FIG. 3, for clamping ends 52 and 56 of the elongated flexible means 50. Such clamping means 60 may be of a well known slotted fastener 62 having a slot (not shown) in a shank portion 63. The slotted fastener 62 will be inserted trough a second aperture 42 provided in the first surface portion 12, preferably intermediate the predetermined plurality of first apertures 34-40, with the ends 52 and 56 caged against the rear surface 16 with a second fastener 64 such as a wing nut 64.

In another alternative embodiment, the attachment means 30 may be provided by a pair of first apertures 34 and 38 in combination with the clamping means 60.

Yet in another alternative embodiment, the attachment means 30 may be formed by one end of the elongated flexible means 50 rigidly attached to the step means 11, preferably adjacent one edge of the first portion 12, and the other end received by at least one aperture 38 and secured with clamping means 60 or received by a pair of apertures 38 and 40 and secured by means of loop 58 and further in combination with the clamping means 60.

Still in another alternative embodiment, shown in FIG. 4, the elongated flexible means 50 may be formed by a first portion having a first end 51 rigidly attached to one edge of the first portion 12 and having the second end 52 wrapping around the structure 8 and a second portion having a first end 55 rigidly attached to the second edge of the first portion 12 and having the second end 56 wrapping the structure 8. Such second ends 52 and 56 are then joined in tension by the clamping means 60 enabling attachment of the step bracket 11 to the structure 8. Advantageously, such attachment of the step bracket 11 may eliminate the need for fulcrum means 18.

Yet in a further alternative embodiment, in further reference to FIG. 4 the elongated flexible means 50 of an unitary configuration may cooperate with a pair of apertures (not shown) disposed in the first portion 12 for attachment of the step bracket 11 to the structure 8.

The climbing device 10 may be further provided with a means 70 engaging at least the second surface portion 20 for providing a positive traction upon engagement of the foot (not shown) with such second surface portion 20. Such traction means 70 may be a well known Safety-Walk™ material manufactured by Minnesota Mining and Manufacturing Company, Saint Paul, Minn. and having a friction producing matter applied to one side and a pressure-sensitive adhesive applied to a reverse side for attachment to at least the second portion 20.

Alternatively, such means 70 may be at least one and preferably, a predetermined plurality of apertures 74 each preferably having an edge 76 elevated above the surface of the second portion 20.

Alternatively, such climbing device 10 may be manufactured from a well known safety plate material (not shown).

Still alternatively, such means 70 may be formed by at least one ridge (not shown) disposed on the surface of the second portion 20.

The climbing device 10 may be additionally provided with a means 80 at least partially engaging the elongated flexible means 50 or a predetermined portion of such step bracket 11 for ease of recognizing such climbing device 10 from a distance. Preferably, such means 80 is a reflective coating for ease of identification of the step member 11 at night, with aid of the moonlight or with the use of a flashlight like device. Alternatively, such means 80 may be a reflective tape (not shown).

Those skilled in the art will understand that although the drawings describe a step member 11 having an uniform width throughout the first, second and third portions 12, 20 and 22 respectively, various widths of such first, second and third portions 12, 20 and 22, respectively, will provide identical functionality of the climbing device 10.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

1. A climbing device for selectively facilitating ascent and descent of a vertical structure, such structure is one of a tree, a pole, a column, and the like, said climbing device comprising:
(a) a step means having a predetermined shape, said step means movable between a first position and a second position for connection to such structure, said step means including:
(i) a first portion having a first predetermined surface area and at least partially engaging such structure in said second position,
(ii) a fulcrum means disposed at one end of said first portion, and
(iii) a second portion having a second predetermined surface area and outwardly extending from a distal end of said first portion, whereby said second portion is disposed generally horizontally in said second position; and
(b) means for attaching, said means for attaching said step means to such structure including:
(i) an elongated flexible means engageable with said step means and such structure for removably attaching said step means thereto, and
(ii) means disposed in said first predetermined surface area of said first portion for securing said elongated flexible member to said step means, whereby said fulcrum means generates tension within said elongated flexible means when said step means is moved from said first position to said second position.

2. The climbing device, according to claim 1, wherein said climbing device further includes means outwardly extending from said second portion for guiding a foot for engagement with said second portion.

3. The climbing device, according to claim 1, wherein said means disposed within said first portion of said step member includes a predetermined plurality of first apertures having a predetermined shape and disposed in a predetermined pattern for receiving ends of said elongated flexible means and securing said elongated flexible means to said step means.

4. The climbing device, according to claim 3, wherein said predetermined plurality of said first apertures is a first pair of said first apertures aligned along a first edge of said first portion for receiving a first predetermined portion of said elongated flexible means disposed adjacent a first end thereof and a second pair of said first apertures aligned along a second edge of said first portion for receiving a second predetermined portion of said elongated flexible means disposed adjacent a second end thereof, whereby said first predetermined portion forms a first loop in cooperation with said first edge of said first portion, said first loop securing said first end and said second predetermined portion forms a second loop in cooperation with said second edge of said first portion, said second loop securing said second end.

5. The climbing device, according to claim 3, wherein said predetermined plurality of said first apertures is a pair of said first apertures with each of said pair of said first apertures disposed adjacent each edge of said first portion of said step means for receiving said ends of said elongated flexible means.

6. The climbing device, according to claim 1, wherein said means disposed within said first portion of said step member includes at least one first aperture disposed adjacent one end of said first portion of said step means for receiving a first end of said elongated flexible means upon engagement thereof with such structure, whereby a second end of said elongated flexible means is rigidly attached to said step means.

7. The climbing device, according to claim 1, wherein said climbing device further includes a means for clamping free ends of said elongated flexible means.

8. The climbing device, according to claim 7, wherein said means for clamping includes a first fastener having a shank portion insertable through a second aperture disposed within said first portion of said step member, said shank portion receiving said free ends of said elongated flexible means and a second fastener threadably engaging said shank portion and caging said free ends against a surface of said first portion.

9. The climbing device according to claim 1, wherein a material of said step member is one of a metal, a rigid polymer, and a combination thereof.

10. The climbing device, according to claim 1, wherein said elongated flexible means is one of a cable, a rope, a chain, and a strap.

11. The climbing device, according to claim 10, wherein said elongated flexible means is said cable.

12. The climbing device, according to claim 11, wherein a material of said cable is one of a metal, a polymer and a combination thereof.

13. The climbing device according to claim 1, wherein said climbing device further includes a means for providing positive traction of a foot with said second portion.

14. The climbing device, according to claim 1, wherein said climbing device further includes means for visually distinguishing said climbing device from a distance.

15. The climbing device, according to claim 14, wherein said means for visually distinguishing said climbing device from a distance is one of a reflective coating, a reflective tape and a combination thereof, said means for visually distinguishing said climbing device from a distance being applied to one of said elongated flexible means, said step means and a combination thereof.

16. A climbing device for selectively facilitating ascent and descent of a vertical structure, such structure is one of a tree, a pole, a column, and the like, said climbing device comprising:
(a) a step means having a predetermined shape and including a first portion having a first predetermined surface area and at least partially engaging such structure and a second portion having a second predetermined surface area and outwardly extending from said first portion, whereby said second portion is disposed generally horizontally upon attachment to such structure;
(b) a pair of elongated flexible means at least partially surrounding such structure, each having a first end rigidly attached to said first portion of said step means; and
(c) means for clamping free second ends of said pair of said elongated flexible means, whereby said pair of said elongated flexible means are placed in tension for securing said step means to such structure.
